(19) United States
(12) Patent Application Publication
(10) Pub. No.: US 2003/0205913 A1
(43) Pub. Date: Nov. 6, 2003

(54) Drag-dropper

(76) Inventor: Ralph Liam Leonard, New Haven, CT (US)

Correspondence Address: Ralph Leonard, Apartment 400, 1145 Chapel Street, New Haven, CT, 06510, US

(21) Appl. No.: 10/135,084

(22) Filed: May 1, 2002

(51) Int. Cl. B60J 1/00

(52) U.S. Cl. 296/180.4

(57) ABSTRACT

The Drag-Dropper is a collapsible structure made of rigid components that may be unfolded to form a modified pyramid to streamline the posterior aspect of trucks. The exact dimensions of the apparatus may be varied such that small to large trucks including semi-tractor-trailers may be fitted. As safety is always the foremost priority, the design has structural redundancy to reduce if not eliminate destruction during operation even if one of several essential component were to fatigue simultaneously from material failure. Likewise, the dimensions seek to maximize posterior drag reduction without additional functional length of the vehicle that would obstruct the driver's rear vision, and the apex is intentionally far above the height of most passenger vehicles in the event of a collision involving a trailing vehicle.

The exact material composition, dimensions and means by which it is affixed to the trailer may change and all such variations when crafted in the described design comprise the scope of this patent application.

CROSS-REFERENCE TO RELATED APPLICATIONS

| Patent | Date of | | |
|---|---|---|---|
| number | patent | First Author | Title |
| 2737411 | Mar. 6, 1956 | Ralph Potter | Inflatable streamlining apparatus for vehicle bodies |
| 4006932 | Feb. 8, 1977 | Alan McDonald | Inflatable drag reducer for land vehicles |
| 4142755 | Mar. 6, 1979 | Edgar Keedy | Vehicle drag reducer |
| 4214787 | Jul. 29, 1980 | Frank Chain | Drag reducing apparatus.. |
| 4236745 | Dec. 2, 1980 | Grover Davis | Retractable streamlining device for vehicles |
| 4257641 | Mar. 24, 1981 | Edgar Keedy | Vehicle drag reducer |
| 4401338 | Aug. 30, 1983 | Kenneth Caldwell | Streamlining device for vehicles |
| 4451074 | May 29, 1984 | Barry Scanlon | Vehicular airfoils |
| 4508380 | Apr. 2, 1985 | Mithra Sankrithi | Truck afterbody drag reducing device. |
| 4601508 | Jul. 22, 1986 | Paul D. Kerian | Streamlining appendage for vehicles |
| 4688841 | Aug. 25, 1987 | Mark Moore | Drag reduction device for tractor-trailers |
| 4702509 | Oct. 27, 1987 | Morris Elliott | Long-haul vehicle streamline apparatus |
| 4741569 | May 3, 1988 | Paul F. Stuphen | Inflatable Drag Reducer for land transport vehicles |
| 4978162 | Dec. 18, 1990 | Francois P. Labbe | Drag reducer for rear end of vehicle. |
| 5058945 | Oct. 22, 1991 | Morris Elliott | Long-haul vehicle streamline apparatus |

### STATEMENT REGARDING FEDERALLY SPONSORED RESEARCH OR DEVELOPMENT

There were no direct or indirect federally sponsored research money or support given for the development of this application or idea.

### REFERENCE TO A MICROFICHE APPENDIX

Does not apply.

### BACKGROUND OF THE INVENTION

It is well known that air resistance is the major external resistive force that fast moving vehicles must overcome. Assuming a vehicle is not on an incline and there are no inclement weather conditions (i.e., no wind, rain or snow), total external resistive force (ƒₜ) can be estimated as the sum of road friction (ƒᵣ) plus air friction (ƒₐ). These latter forces are in turn the result of several factors defined as:

ƒᵣ=μN and ƒₐ=1/2CAρυ². Thus ƒₜ=μN+1/2CAρυ²

Where:

μ=coefficient of friction between two objects; for rubber and concrete this is approximately 1.0.

N=Newton (assuming gravitational force N=mass (in Kg)* 9.8 meters/second²)

C=drag coefficient (this is related to aerodynamics, for a sphere it is 0.5).

A=cross-sectional area of the vehicle's forward moving surface.

ρ=density of air (at sea level it is approximately 1.293 kg/m³)

υ=velocity of vehicle

The power, P, required to overcome this total external resistive force and thus maintain a constant velocity, can be expressed as:

P=ƒₜυ

If one's objective is to maximize efficiency then any or all of the three mutable factors (C, A, υ) could be reduced. Economic incentives are likely to mitigate against reduction of A or υ, thus C may be an excellent candidate for reduction attempts. Given the political uncertainties related to fuel accessibility, one would expect an interest in practical means by which to reduce C.

More specifically, this invention seeks to reduce C, the coefficient of air drag for trucks, by making the rear end of the vehicle more streamlined. This need has been recognized for many years and devices proposed to achieve this goal were first patented over forty years ago. However, such devices have had major practical limitations that can be summarized as follows 1) many are very complicated and would require considerable adaptation of the truck which may be expensive 2) many employ a rigid device that would perhaps be difficult to maneuver in docking stations 3) many attempt to provide flexibility by using inflatable structures so necessitate an impervious yet light material and a very dependable pump, plus ensure such an inflated device could maintain the desired shape even under modem high speed conditions.

### BRIEF SUMMARY OF THE INVENTION

The Drag-Dropper is a collapsible structure made of rigid components that may be unfolded to form a modified pyramid to streamline the posterior aspect of trucks. The exact dimensions of the apparatus may be varied such that small to large trucks including semi-tractor-trailers may be fitted. As safety is always the foremost priority, the design has structural redundancy to reduce if not eliminate destruction during operation even if one of several essential components were to fatigue simultaneously from material failure. Likewise, the dimensions seek to maximize posterior drag reduction without additional functional length of the vehicle that would obstruct the driver's rear vision, and the apex is intentionally far above the height of most passenger vehicles in the event of a collision involving a trailing vehicle.

The exact material composition, dimensions and means by which it is affixed to the trailer may change and all such variations when crafted in the described design comprise the scope of this patent application.

### BRIEF DESCRIPTION OF THE SEVERAL VIEWS OF THE DRAWING

Please note: 1) none of these figures are drawn to scale 2) figures which share the same perspective in a figure (e.g., 1A and 1B, 2A and 2B) have items labeled just once to avoid clutter 3) “left” and “right” are given in terms of the a truck driver's right and left if s/he were seated in the drivers seat looking through the windshield 4) all perspectives are given regarding what a viewer might see if s/he was positioned behind, to the left, right or above the truck; all of these assume the viewer is in those locations but looking towards the back of the truck unless otherwise stated 5) dashed lines indicate an obstructed view of a line 6) 's' shaped curves (whether on its side or in the standard position) indicate the structure has been truncated to save room 7) the “side” of the truck that these pictures refer to are the two vertical sides that run from the front to the back of the truck 8) the term “assembled” refers to the Drag-Dropper in a position such that the panels are all opened and located behind the truck; the term “quasi-assembled” refers to the right and left panels being parallel to the truck sides but one or both of the top and bottom panels are folded 9) since the components of the device can assume several positions, the default one will be with the panels behind the truck in either an assembled position or quasi-assembled position (defined in point 8), 10) all views from above assume that, if the viewer was in the prone position, then her/his head would be closer to the front of the truck than her/his feet would be.

FIG. 1: The series of figures shows: 1a) a stationary semi-truck trailer without a Drag-Dropper 1b) a stationary semi-truck trailer with a Drag-Dropper in the assembled position, 1c) a moving semi-truck trailer without a Drag-Dropper and the associated air-current and drag depiction 1d) a moving semi-truck trailer with a Drag-Dropper and the associated air-current and drag depictions.

FIG. 2: This series of figures shows the dimensions and angles of an assembled Drag-Dropper from several perspectives: 2a) as would be seen by a viewer positioned above the Drag-Dropper 2b) as would be seen by a viewer standing behind the truck 2c) as would be seen by a viewer on the right side of the truck.

FIG. 3: Each panel which comprises the sides of the Drag-Dropper are depicted as if it was lying flat on the ground so that the dimensions only specify the lengths and not the distance to given points when they are assembled: 1a) left panel 1b) right panel 1c) top panel 1d) bottom panel.

FIG. 4: The Drag-Dropper as seen by a viewer on the left side of the truck when the Drag-Dropper is in the 4a) storage position and 4b) quasi-assembled position.

FIG. 5: The Drag-Dropper as seen by a viewer on the left side of the truck with the Drag-Dropper in the storage position with the Panel-brace in the 5a) inactive position and 5b) active position.

FIG. 6: Series of figures depict positions of the left horizontal-pole and left panel as would be seen by a viewer above the truck. The horizontal-poles traverse when folding from the assembled position (6a) to the storage position (6f).

FIG. 7: Two figures which show a more detailed component composition and dimensions of the Drag-Dropper as would be seen by a viewer above the truck when it is in the 7a) assembled and 7b) storage positions.

FIG. 8: Series of figures depict the positions of each panel of the Drag-Dropper as it is assembled, as would be seen by a viewer standing behind the truck. 8a) panels in the storage position 8b) right and left panels are parallel to the vertical sides of the truck, top panel is in the assembled position 8c) left and top panels are in the assembled positions, bottom panel is still folded against the right panel which is still parallel to the vertical sides of the truck 8d) left, top and right panels in the assembled positions; the bottom panel is still folded against the side of the right panel 8e) all panels are in the assembled position.

FIG. 9: Two figures that depict components of the left and top panels and their relations as would be seen by a viewer positioned behind the truck. 9a) the left panel is parallel to the vertical side of the truck and the top panel is in the folded position against the left panel and 9b) the left panel is parallel to the vertical side of the truck and the top panel is open.

FIGS. 10: Series of figures that depict the various positions the top panel traverses as it goes from the folded positions (10a and 10e) to the open positions (10d and 10h) as would be seen from a viewer standing on the left side of the truck (top four figures) or behind the truck (bottom four figures). Top and bottom figures are synchronized in position.

FIGS. 11: Figures depicting the Lock-Rod in various perspectives. 11a) As seen by a viewer behind the truck with the right panel still parallel to the vertical side of the truck when in the “locked position” but without the right panel in place, 11b) As seen by a viewer behind the truck with the right panel still parallel to the vertical side of the truck when in the “guiding position” but without the right panel in place 11c) As seen by a viewer behind the truck with the right panel still parallel to the vertical side of the truck when in the “guiding position” attached to the right panel, which in turn is parallel to the side of the truck 11e) As seen by a viewer behind the truck with the right panel still parallel to the vertical side of the truck when in the “locked position” attached to the right panel, which in turn is parallel to the side of the truck 11d) As seen by a viewer on the left side of the truck with the right panel still parallel to the vertical side of the truck when in the “guiding position” attached to the right panel, which in turn is parallel to the side of the truck 11f) As seen by a viewer on the left side of the truck with the right panel still parallel to the vertical side of the truck when in the “locked position” attached to the right panel, which in turn is parallel to the side of the truck. The following letters indicate dimensions of the following components: A=width of top block, B=length of the top block, C=height of the top block, D=height of hinge, E=height of the bottom block, F=width of the lock-rod, G=width of the bottom block, H=width of the handle and I=width of the lock-rod.

FIGS. 12: Figures depict what a viewer positioned on the left side of the truck (FIGS. 12a and 12b) or above the Drag-Dropper (FIGS. 12c and 12d) would see when the right panel swings from being parallel to the truck side (12a and 12c) to the right panel being in the assembled position (12b and 12d). The top panel is in the assembled position. FIGS. 12a and 12c are synchronized, as are 12b and 12d.

FIGS. 13: Series of figures depict how the Lock-Rod is used to guide and lock the top panel in place. 13a) The right and left panel are parallel to the truck sides, the top and bottom panels are folded; the Lock-Rod is in the “guiding position”. 13b) All components are as in FIG. 13a except the left panel has swung inwards (though not yet in the assembled position) 13c) all components are as in FIG. 13a except the left panel has now swung into the assembled position 13d) all components are as in FIG. 13c except the Lock-Rod has now been inserted into the guide hole of the top panel and the top panel is opening into the assembled position 13e) components in same position as in 13d except the top panel is almost in the assembled position 13f) the top panel is in the assembled position and the Lock-Rod has now been rotated counter-clockwise position so the wide block is pointing towards the viewer and has locked the top panel in the assembled position. The slits in the top panel depicted in FIGS. 13e and 13f are intentionally greater than would occur in actual life to facilitate viewing.

FIGS. 14: Right panel and the folded bottom panel as seen by a viewer standing on the left side of the truck (14a) and the behind the truck (14b). Shows the dimensions and relative sizes.

FIGS. 15: Left panel without the top panel attached so that the peg-ledge, pegs and the handle-window can be seen. 15a) as seen by a viewer standing behind the truck with the left panel behind the truck but in the parallel position (i.e., quasi-assembled position) 15b) as seen by a viewer standing behind the truck with the left panel beside the truck (in the storage position) 15c) as seen by a viewer standing on the right side of the truck.

FIGS. 16: Series of figures that depict the various positions the bottom panel traverses as it goes from the folded positions (16a and 16e) to the open positions (16d and 16h) as would be seen from a viewer standing on the left side of the truck (top four figures) or behind the truck (bottom four figures). Vertical pairs of figures (e.g., 16a& 16e) are synchronized in position. FIGS. 17: Bottom panel in the assembled position as seen from the top of the truck with the locking mechanism in the unlocked (17a) and locked (17b) positions.

FIG. 18: Series of figures as seen from the top of the truck with the bottom panel in the assembled position as the locking mechanism goes from the unlocked (18a) to the locked position (18e).

FIG. 19: Several perspectives of the handle-lock which projects off the “locking arm” on the bottom panel. FIGS. 19a, 19c and 19e are synchronized in the unlocked position; FIGS. 19b, 19d and 19f are synchronized in the locked position. 19a) as viewed looking at the left brace head-on such that the handle is behind the left brace but can be seen jutting above the left brace; 19b) as viewed looking at the left brace head-on such that the handle is behind the left brace and not viewable since in the locked position 19c) as viewed if a viewer is on the left side of the truck and the Drag-Dropper is assembled, here with the lock in the unlocked position 19e) as viewed if a viewer is on the left side of the truck and the Drag-Dropper is assembled, here with the lock in the locked position 19f) as viewed if the viewer is looking along a plane parallel to the left panel and can perceive where the handle juts through the window in the left panel; apparatus in the unlocked position. 19g) same as in 19f but apparatus in the locked position.

FIG. 20: Views of the left panel-brace in various positions. FIGS. 20a, 20b, 20c and 20f are viewed as by a viewer is standing on the left side of the truck; FIGS. 20d and 20e are viewed by a viewer standing at the front of the truck and looking towards the back but is able to see the bolt insertions. FIGS. 20b and 20c demonstrate the panel-brace may swing in the plane parallel to the truck side. FIGS. 20e and 20f demonstrate the panel-brace may swing in the plane perpendicular to the truck side.

FIG. 21: Views of the lower aspect of the left panel-brace as it enters the lock-box. FIGS. 21a, 21b, 21c show the figures as seen by a viewer standing on the left side of the truck. FIGS. 21d, 21e and 21f show the left panel as seen by the a viewer standing at the front of the tuck and looking towards the back. Figures are synchronized in their vertical positions to depict how the spring-loaded pin locks (e.g., synchronized pairs are 21a & 21d, 21b & 21e, 21c & 21f) when going from the panel-brace not having yet entered the lock-box (FIGS. 21a & 21d); entered the lock-box with the pin in the retracted position (FIGS. 21b & 21e) and with the pin in the locked position (FIGS. 21c&21f).

FIG. 22: Views of the left upper swivel brace. FIGS. 22a, 22b and 23c depict the swivel brace as would be seen from a viewer above the Drag-Dropper with the left panel behind the truck and parallel to the truck side (22a), left panel behind the truck in the assembled position (22b), left panel beside the truck in the stored position (22c). FIG. 22d is the swivel brace as seen by a viewer standing on the left side of the truck with the left panel behind the truck in either the parallel or assembled position. FIGS. 22e and 22f is the right swivel brace as seen by a viewer who is located at the front of the truck and looking toward the back when the arm from the horizontal pole is (22f) or is not (22e) connected. (This L-arm is always connected in the actual apparatus, but is removed in these figures to illustrate component parts and relationships).

FIG. 23: Views of the left Pivot-Rod from various perspectives. FIGS. 23a and 23b are seen by the viewer standing on the left side of the truck when the stubs point towards either the back of the truck (23a) or directly at the viewer (23b). FIG. 23c and FIGS. 23d depict the left Pivot-rod as seen by a viewer standing behind the truck when the stubs point towards the viewer (23c) or are perpendicular to the side of the truck as might be seen when the panels of the Drag-Dropper are being rotated from the assembled or quasi-assembled position to the storage positions (23d). FIGS. 23a & 23c are synchronized, as are FIGS. 23b & 23d.

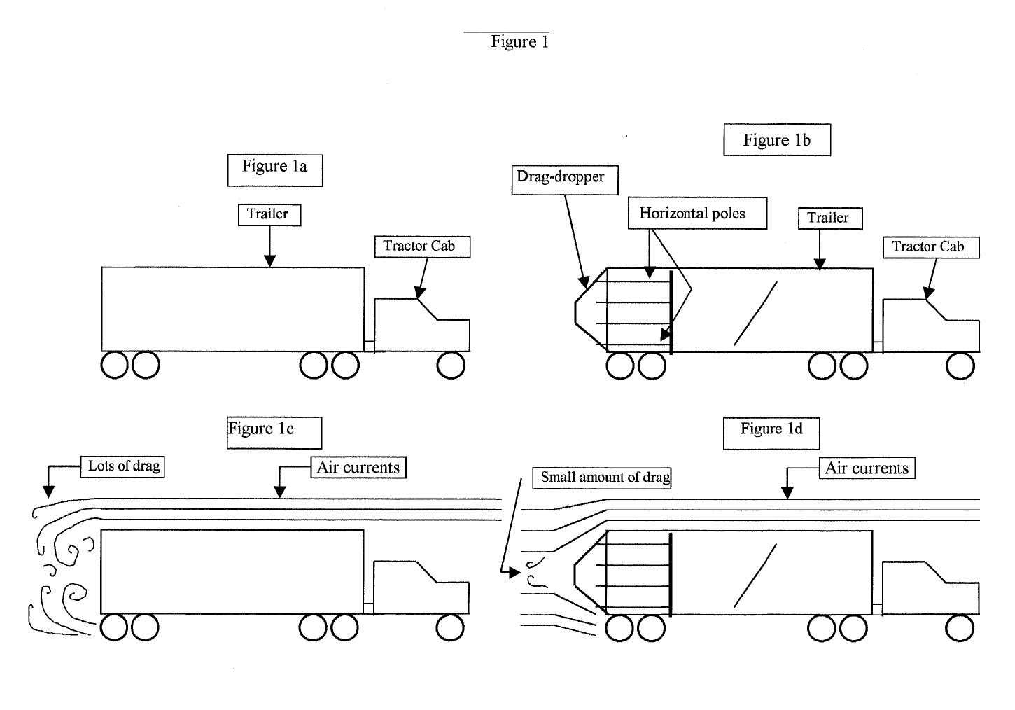

### DETAILED DESCRIPTION OF THE INVENTION

The Drag-Dropper may be conceptualized as being comprised of three component sets: 1) four panels that, when assembled, create a modified pyramid shape 2) structures internal to the assembled Drag-Dropper that assist in locking the panels together and 3) support structures external to the assembled Drag-Dropper that connect it to the trailer. Each of these will be described with regard to their size, relationships and function.

Section 1: Four Panels that when Assembled, Create a Modified Pyramid Shape.

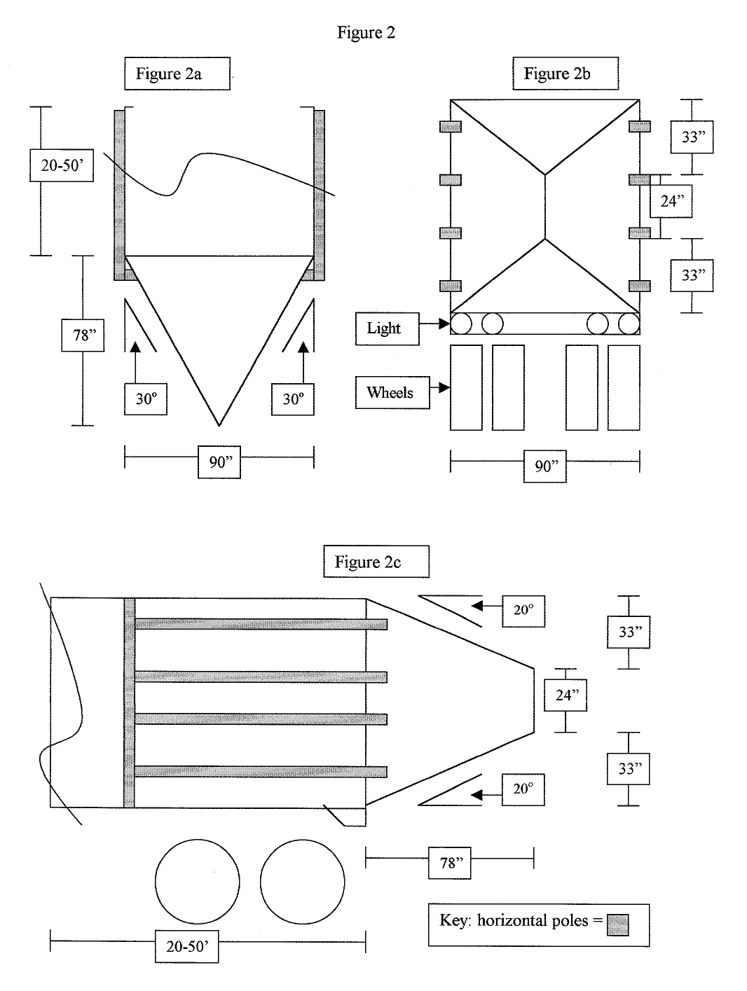

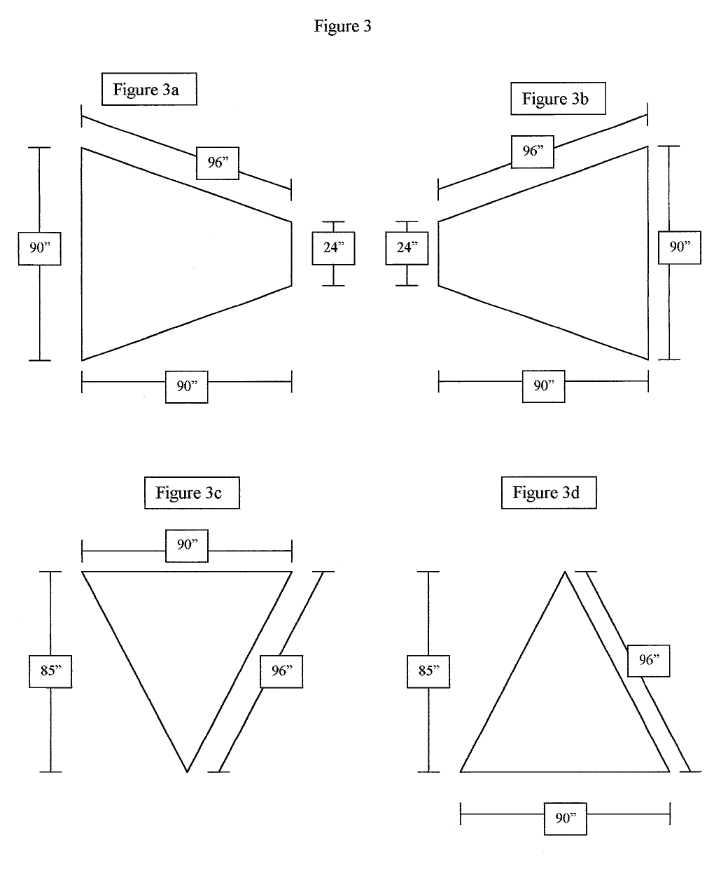

The panels have two basic shapes: those that comprise the vertical sides of the Drag-Dropper (FIG. 3a and FIGS. 3b) and those that cover the top and bottom (FIG. 3c and FIGS. 3d). (The narrower side of the trapezoid like structure of the side panels will be referred to as the vertex; the corresponding point of the triangles for the top and bottom panels that contact those vertices when in the assembled position will also be referred to as vertices.) The lengths of their sides is as depicted in FIG. 3 and when assembled they form a structure as depicted in FIG. 2: the vertical sides have a 30° inward deflection from the vehicle's sides, the bottom and top panels deflect 20° from the top and bottom sides of the trailer, respectively. When in the assembled position the Drag-Dropper projects 78″ behind the vehicle (FIG. 2c) and its tip is elevated at least 33″ above the bottom of the trailer edge. Importantly, the assembled panels do not form a single point as in a classical pyramid but rather the point is distributed over at least 24″ to avoid excessive pressure in the event of a collision.

The width of each panel and its components are dependent upon the material composition so are not specified here exactly. However, it is expected that each panel width is at least 0.5″.

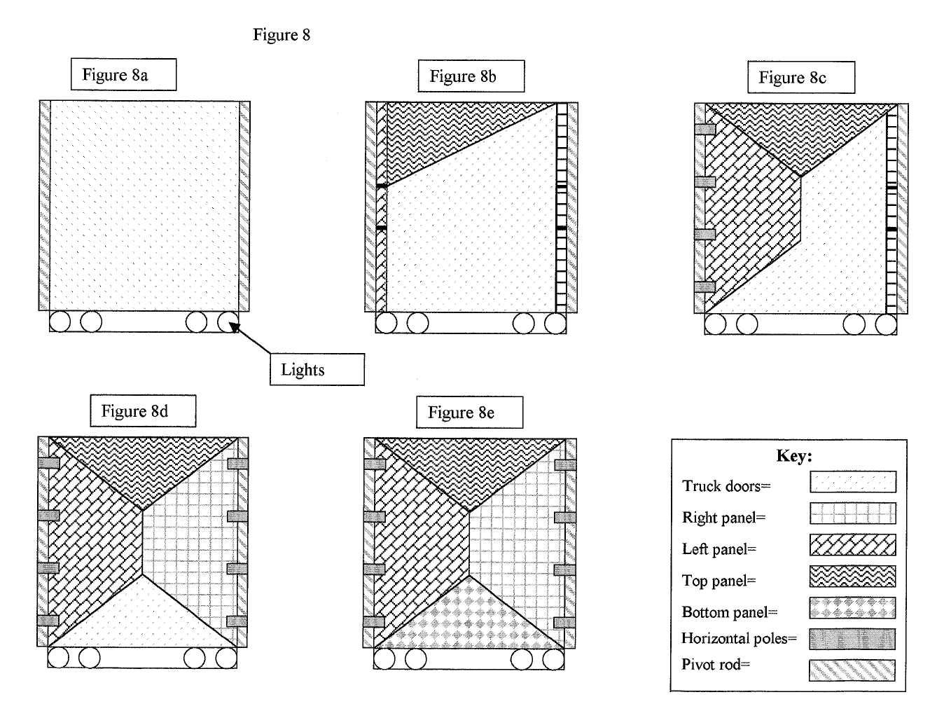

The assembly of the panels must follow a specific order such that the internal locking mechanisms can function. This sequence is illustrated in FIG. 8:

1) the Drag-Dropper with the panels in the storage position (8a)

2) the left and right panels are swung so they extend behind the truck but remain parallel to the vertical sides of the truck, then the top panel is unfolded from the left panel (8b)

3) the left panel is rotated inward 30° such that the top edge of the top panel is flush against the truck trailer (8c).

4) the right panel rotates inward 30° such that the right and left panels connect at their vertices (8d)

5) the bottom panel is unfolded from the right panel, thus completing the assembled position (8e).

The left panel has a small hole which allows the handle of the bottom panel to project through it and a small brace that the handle locks to. The top panel has a small hole in it which allows the locking-bar to pass through it. All of these points will be described more below.

To disassemble the Drag-Dropper one would reverse the sequence of events.

The composition of the panels may be one of several materials, but the recommended material is impermeable and rigid (e.g., fiberglass) so the shape is not distorted by wind but can collapse in the event of a posterior collision exceeding a pre-specified force.

Section 2: Structures Internal to the Assembled Drag-Dropper that Assist in Locking the Panels Together

There are a number of components attached to the four basic panels to help ensure the assembled Drag-Dropper maintains a secure structure and to assist in reaching this position. There are two permanent connections that secure two pairs of panels and two mobile mechanisms which connect two other pairs of panels. Each will be described in detail.

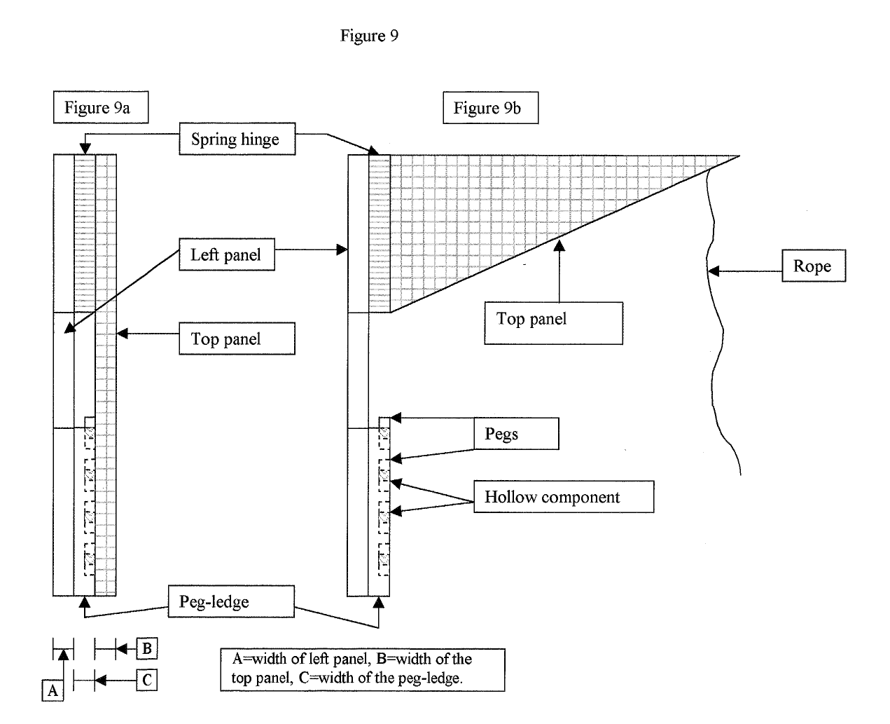

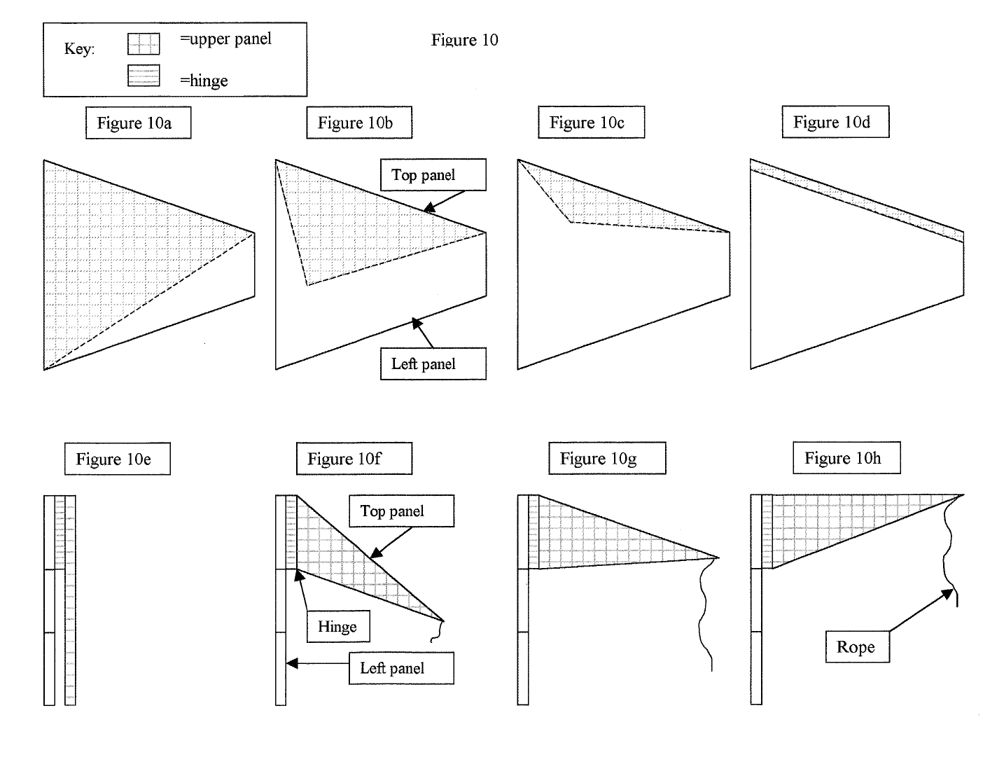

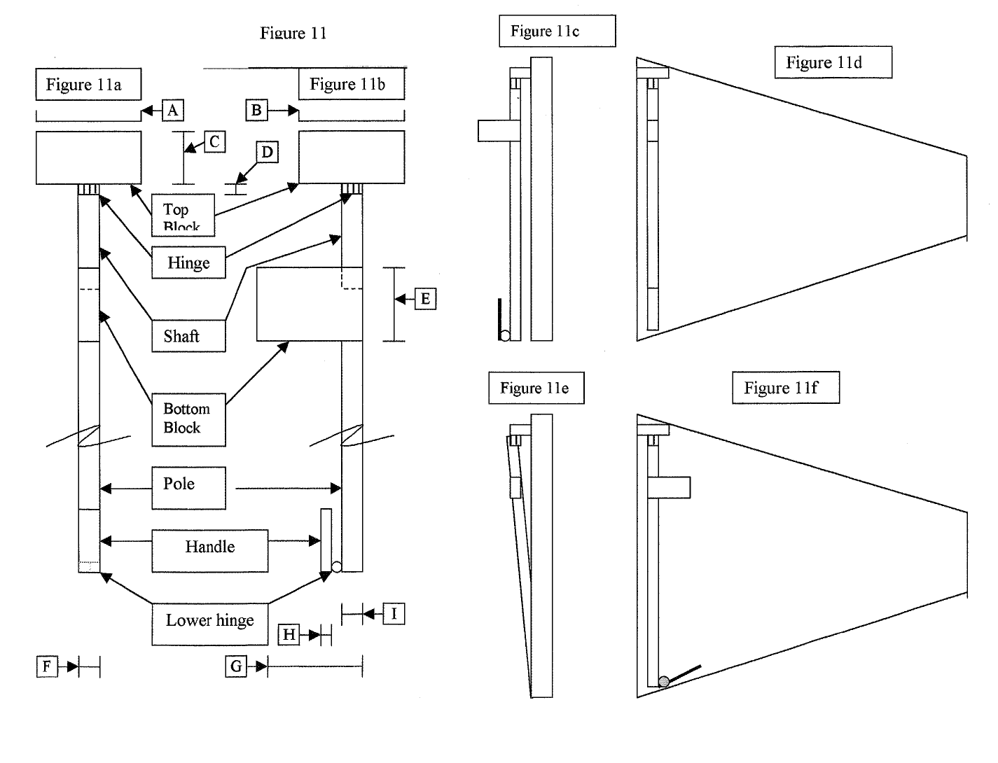

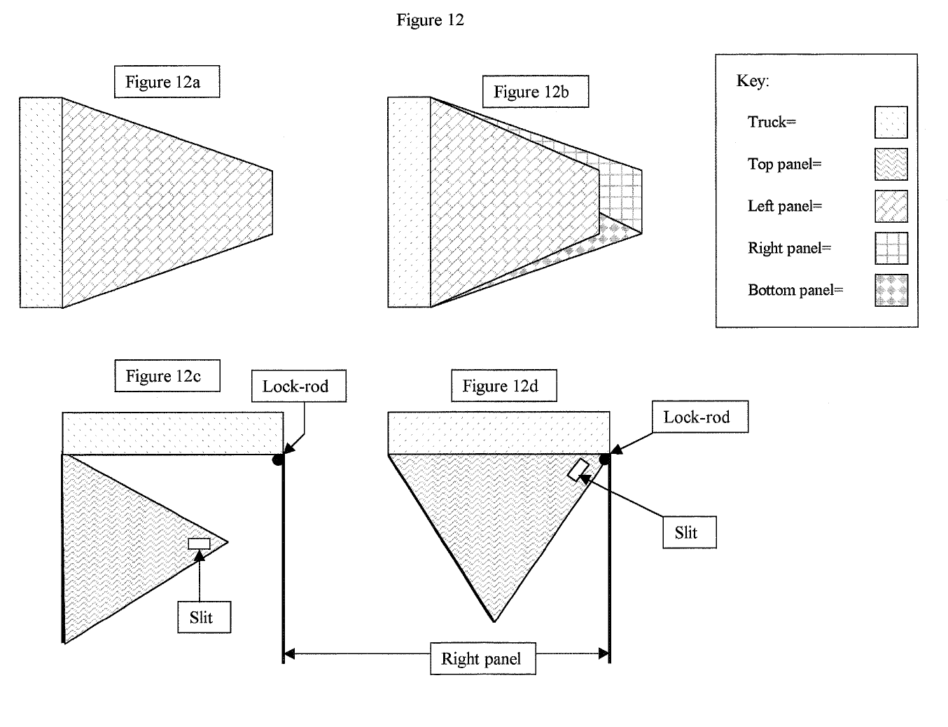

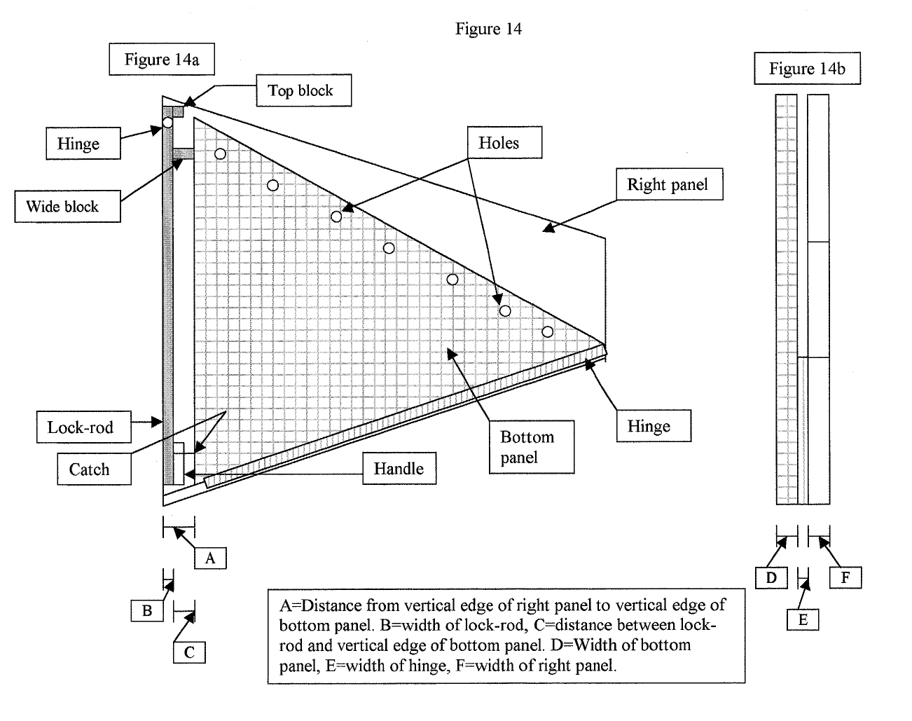

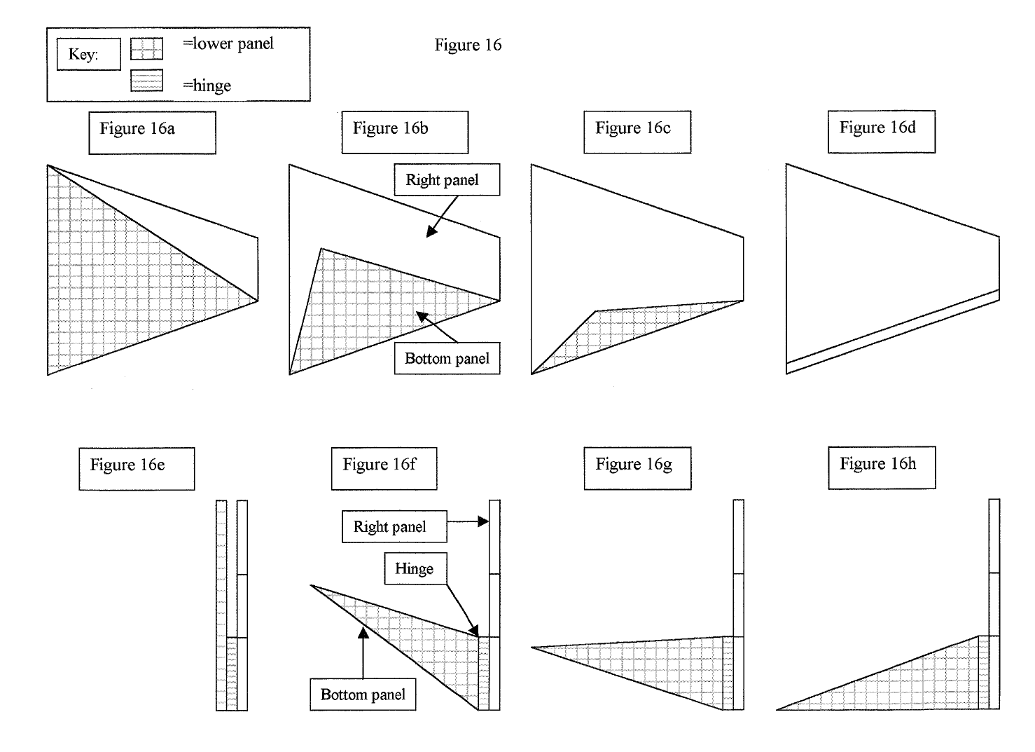

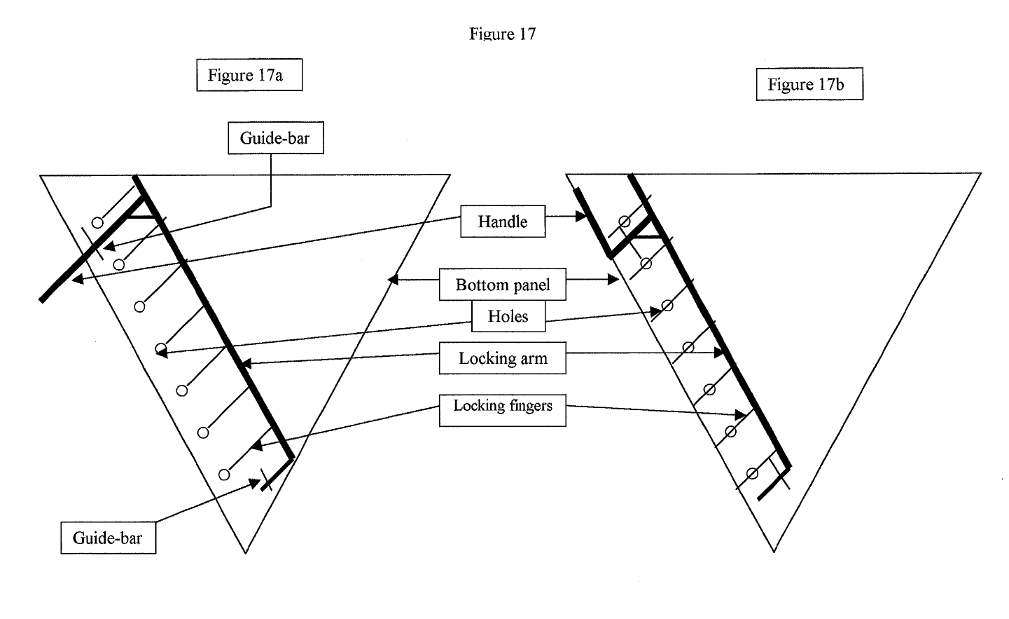

Permanent connections: A spring-loaded hinge connects the edges of the left panel and top panel as shown in FIGS. 9 and 10. The spring forces the top panel to unfold and is strong enough to support the weight of the top panel; however it is not excessive and can be easily overcome when the driver pulls on a rope attached to the tip of the top panel when s/he wishes to refold the top panel. Analogously, a hinge (without a spring) permanently connects the edges of the right panel and the bottom panel as shown in FIGS. 14 and 16. When released, the bottom panel lowers to its unfolded position (FIG. 16). The exact width of the hinge and spring-hinge are dependent upon the material used but would be expected to be less than 0.5″.

Mobile connections: The means by which the top panel attaches to the right panel and the means by which the left panel attaches to the bottom panel are somewhat more complex and involve mobile and stationary components so will be described separately. The next two paragraphs describe how the top and right panels connect; the subsequent two paragraphs describe how the left and bottom panels connect.

Connection of the top panel and right panel: A vertical pole, called the “locking-rod” is depicted in FIGS. 11, 13 and 14. This pole is comprised of a top block that is permanently attached to the upper corner of the right panel, has a hinge on its underside that allows rotation in the plan perpendicular to the right panel; the other side of the hinge is a slender shaft that extends into the “bottom block” which is in turn connected to a longer, slender pole which has a handle on its bottom end. The top-block is shaped as a cube but the dimensions of the bottom block are all unequal so that, when viewed from an observer behind the truck, the resulting width is narrow when the handle points towards the observer (FIGS. 11a, 11e) but is wide when the handle is pointed to the left of the truck (FIG. 11c). Similarly, when viewed from the left of the truck, the bottom-bock appears narrow when the handle points towards the observer (11d) or wide when the handle points towards the vertex of the right panel (11f).

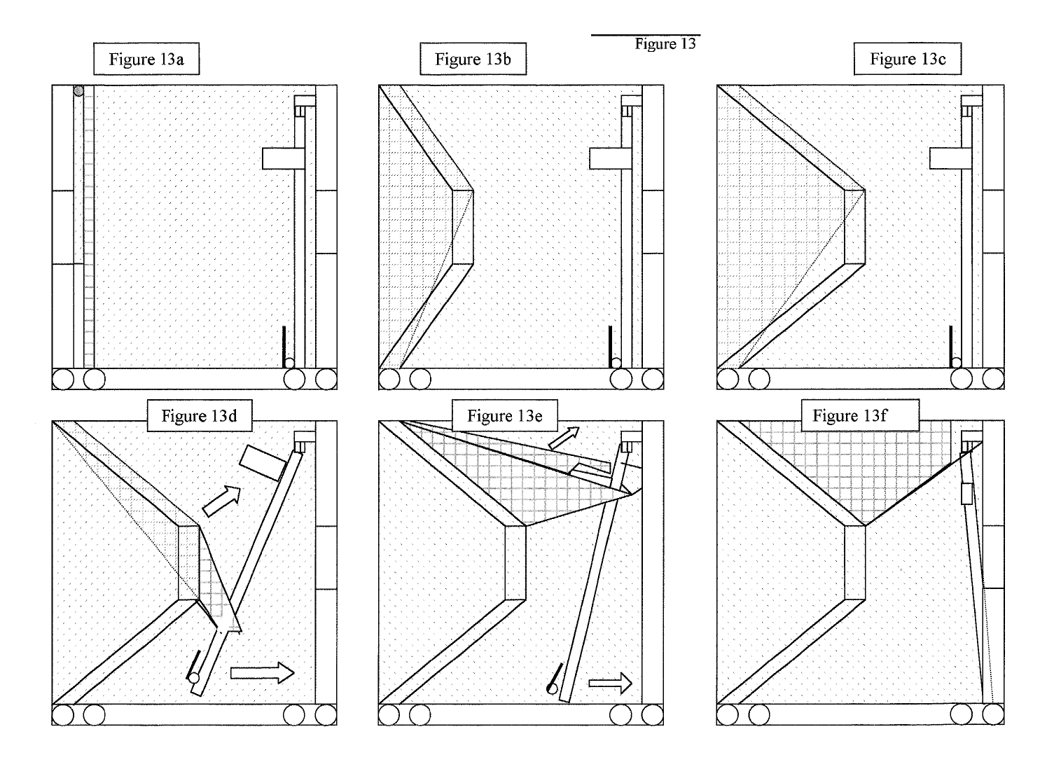

The locking rod works to secure the top panel and right panel together as depicted in FIG. 13 and as described here: the top panel is unfolded slowly and the distal end (with the handle) of the locking-rod is inserted through a small rectangular hole in the top panel; the handle of the locking-rod is turned towards the left truck side so that the bottom-block's dimensions are concordant with the rectangle's hole (the so-called “guiding position”) and as the top panel unfolds its right tip slides up the locking-rod until it rests just below the top-block. The locking rod is then swung back towards the right panel then the handle is turned counter-clockwise which rotates the top-block into the so called “locking position” such that the top-panel is locked in the unfolded position. As with other elements in the mobile components, the size of the locking-rod and its respective dimensions are dependent upon the material composition. However, an optimal approach would involve the pole width of less than 0.5″, top-block's cube dimension of 2″ and the bottom-block's dimensions of 2″×4″×2″; additionally, the dimensions in FIG. 14 would depend upon the material used but their relative sizes are approximated here.

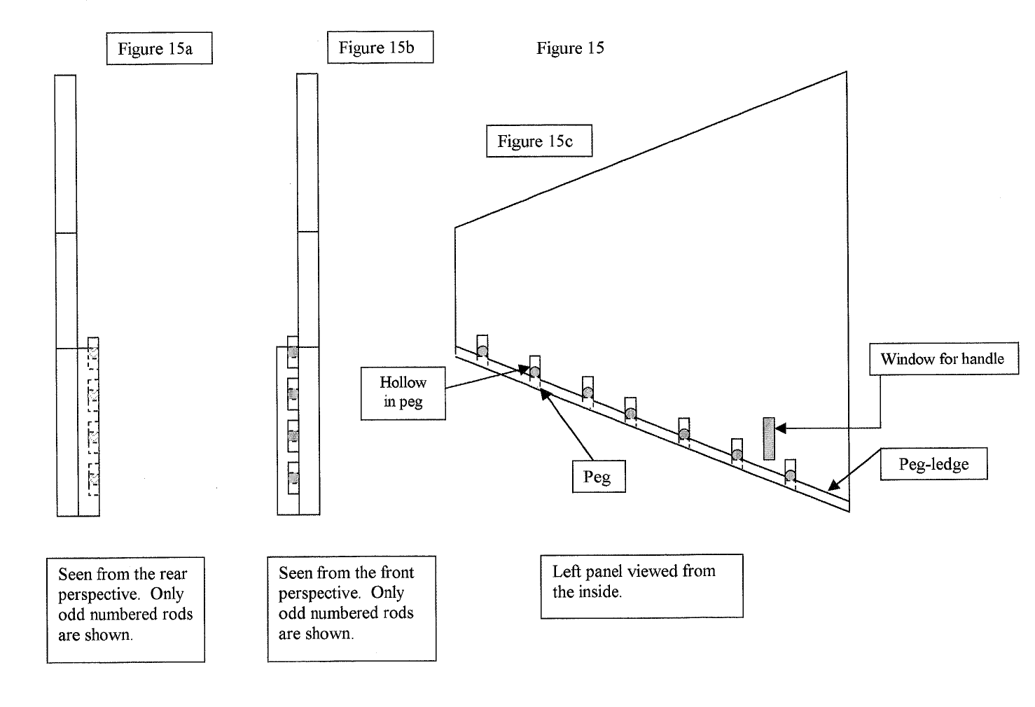

Connection of the top and right panel: A series of short, rigid cylinders (pegs) are permanently affixed in a vertical position to a ledge (so called peg-ledge) that is in turn attached to the left panel and runs along the lower edge of the left panel (FIG. 15). The peg-ledge extends out at least 3″ and each peg is at least 1″ and has a central hollow as seen by an observer standing at the right side of the truck (15c). The bottom panel has an equal number of circular holes as there are pegs on the peg-ledge (in this example I have made 7 pegs and 7 peg-holes) which have a slightly larger diameter and when unfolded the holes in the bottom panel surround the pegs such that the pegs project through the bottom panel (FIG. 14).

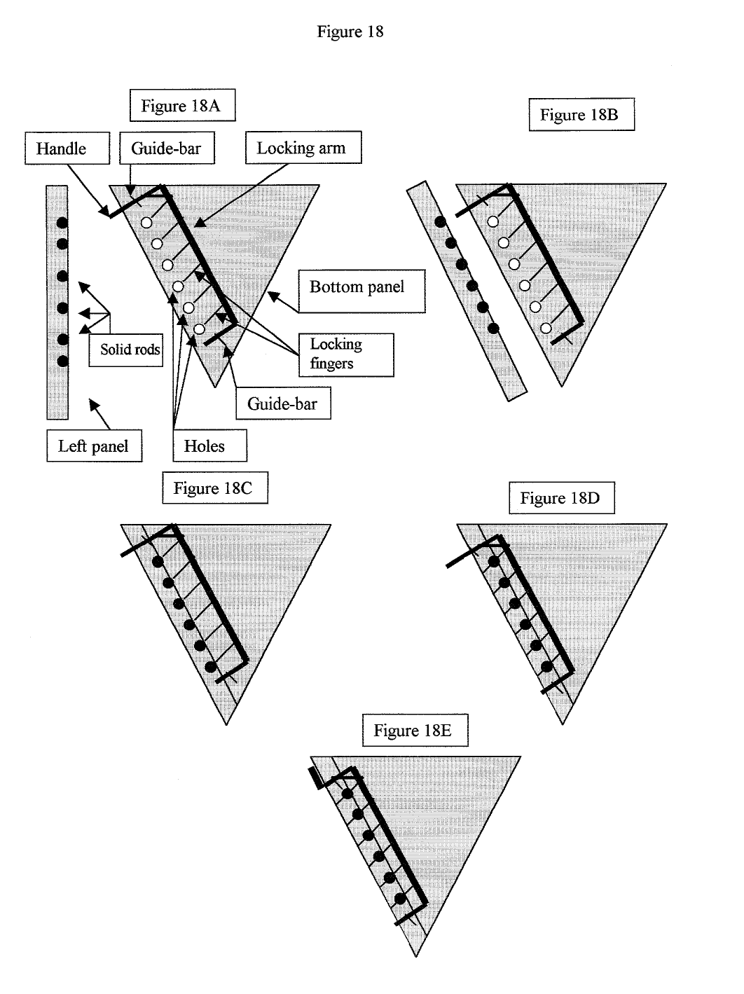

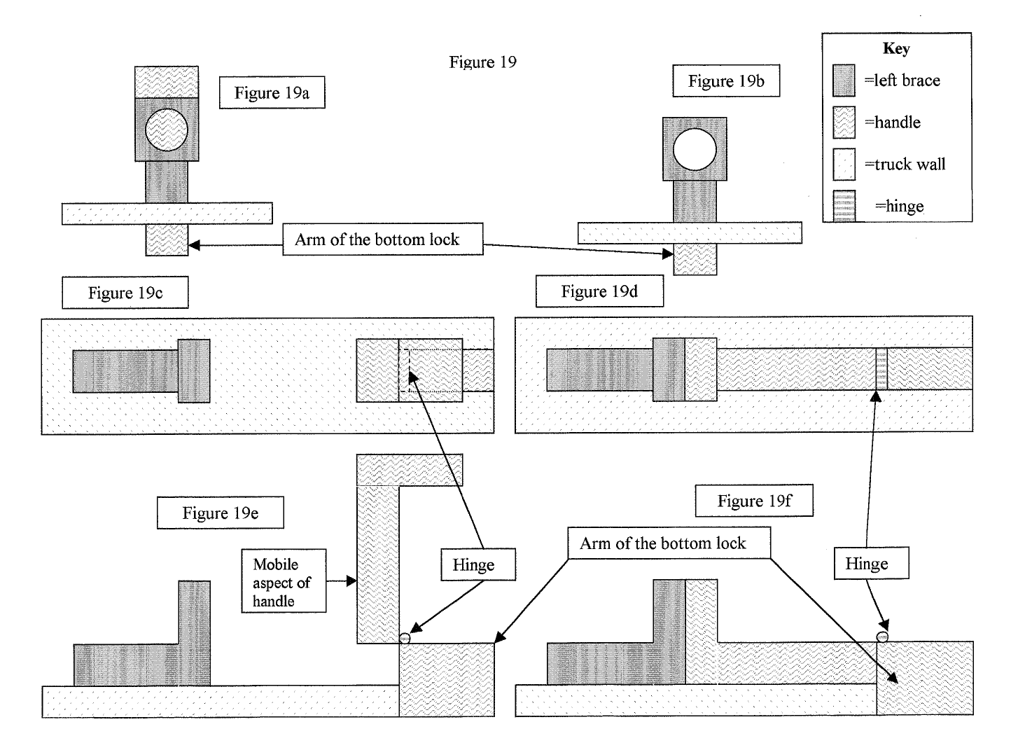

The bottom panel has a special apparatus called the locking-arm that has locking-fingers extend from it in a parallel manner and can be pulled in a plane parallel to the bottom-panel by a handle that projects through a small window in the left panel (FIG. 17). The locking-arm is affixed to the bottom-panel by guide-bars which allow it to be moved in a plane towards or away from the edge with the holes. Once the bottom panel has been lowered such that the pegs from the left panel project into the bottom panel, the locking arm is pulled towards the left panel such that the fingers pass through the hollow parts of the pegs (FIG. 18) and then the handle is folded against the external component of the left panel (FIG. 17b, 18e) such that it connect with an external brace on the left panel and can be locked with a pad-lock (FIG. 19).

To disassemble the Drag-Dropper, the above sequence of steps is done in reverse. Importantly, only one pad-lock is required to secure the structure and, though one could use an alternative method, given the very dangerous consequences of structural collapse if the handle was tampered without the knowledge of the driver, this is a necessary safety component.

Section 3: Support Structures External to the Assembled Drag-Dropper that Connect it to the Trailer.

There are three external components which can be grouped as 1) those that secure the panels of the Drag-Dropper to the horizontal poles 2) the apparatus used to swing the panels of the Drag-Dropper from the quasi-assembled position to the storage position and 3) the panel-brace which secures the panels while in the storage position. One paragraph will be given to describe each of these in this order.

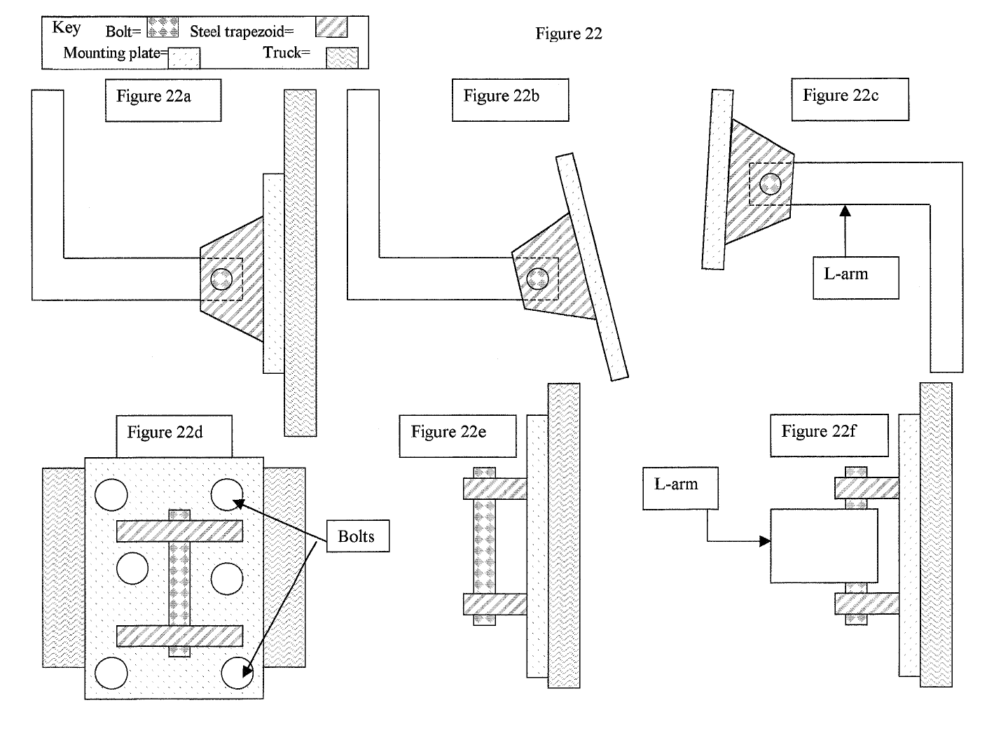

Apparatus to secure the panels to the horizontal poles: The swivel brace depicted in FIG. 22 comprises a simple bolt that passes through two steel trapezoids in turn mounted on a plate that attaches to the right or left panels. There may be any number of these swivel braces (I have drawn in 4 for each of the left and right panels) and the distal tip of a horizontal pole is permanently connected to these when the bolt is passed through a hole in the horizontal pole then welded in place. When the swivel brace is attached to the panel and the horizontal pole, it may assume several angles that allow the panels to move 30° inward when being assembled (FIG. 22b) and facilitate the vertices of the right and panel to be flush against the side of the truck when in the storage position (FIG. 22c).

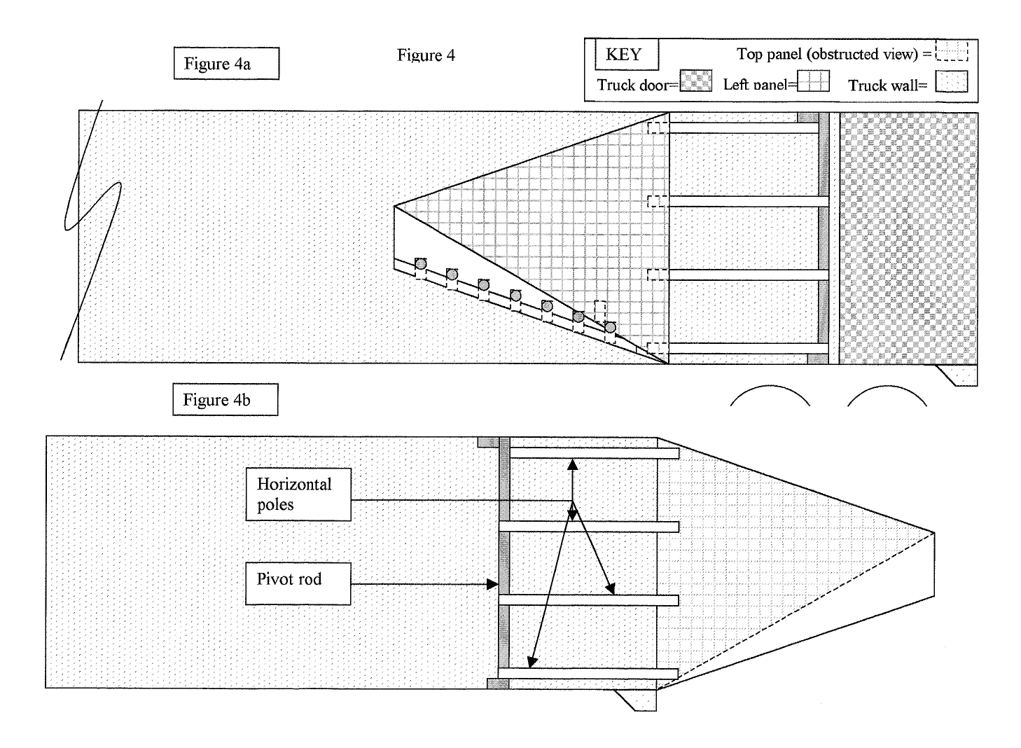

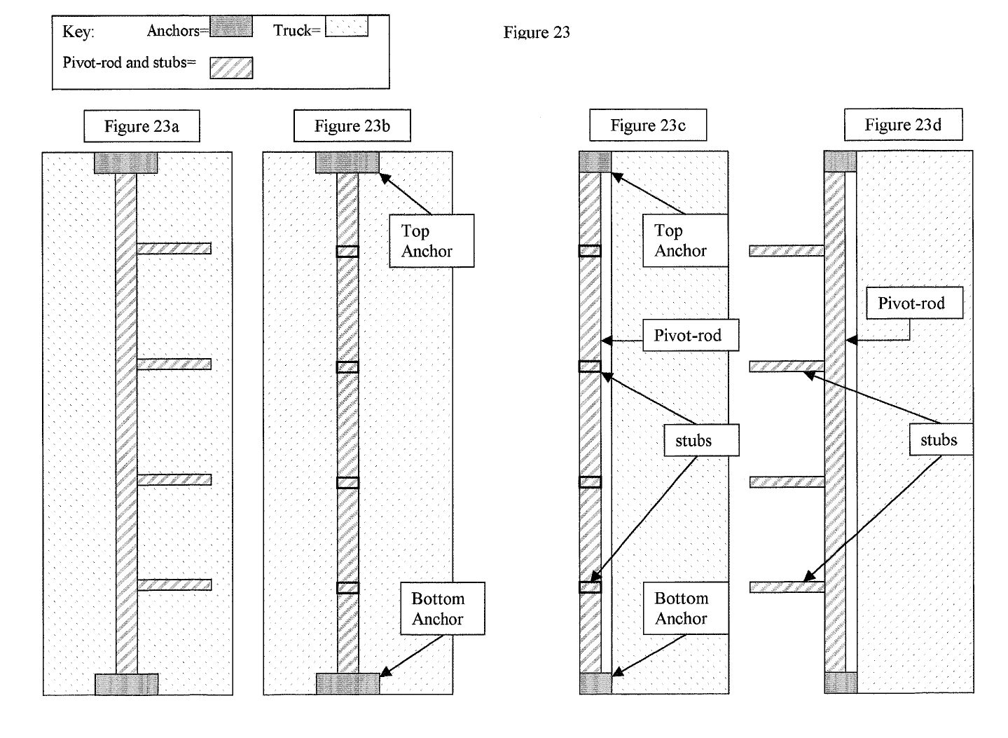

Apparatus used to swing the panels: The pivot-rod is a vertical rod secured to the trailer by anchors and that has a number of stubs projecting perpendicular from it, the latter of which are hollow and accept the proximal tips of the horizontal poles (FIG. 23). The exact number of stubs can vary depending upon the size of the vehicle, and the length of the horizontal poles can also vary so that the pivot-rod could be located close to the back door (in the case where the back-door is opened vertically as in a roll-up door) or significantly far from the back doors (in the case where the back-door is swung open and lies against the sides of the truck. The horizontal poles chosen for a given installment may be short or long depending upon the location of the pivot rod, but each has a right-angle (so called L-arm as in FIG. 22) just prior to attachment with the swivel joint; the distance of this L-arm may be varied upon the size of the vehicle but generally should be short so the panels make contact just inside the edge of the side walls (but far enough in so air can not accidentally enter the interior of the assembled Drag-Dropper). The horizontal poles would be securely affixed to the stubs and the anchors of the pivot-rods would by a securely affixed to the trailer when the Drag-Dropper and its supporting structures are installed on the truck. When swung into the storage position (FIGS. 4,6,7) the panels move in a semi-circle whose center is the pivot-rod and radius is sum of the length of the stubs, horizontal pole and the length of the panels.

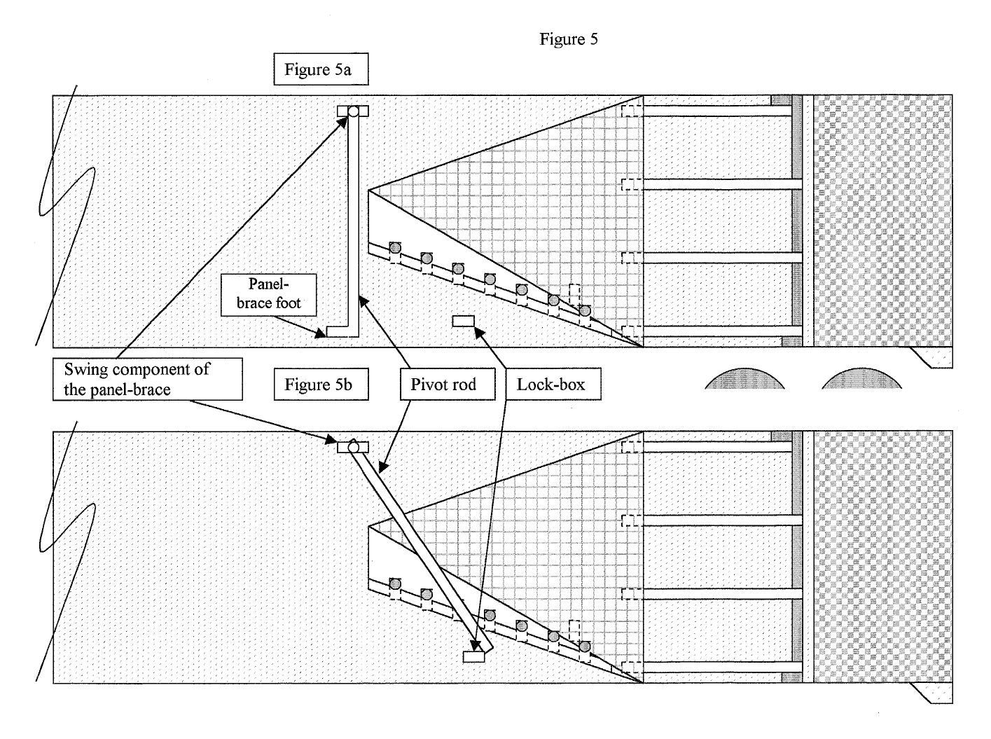

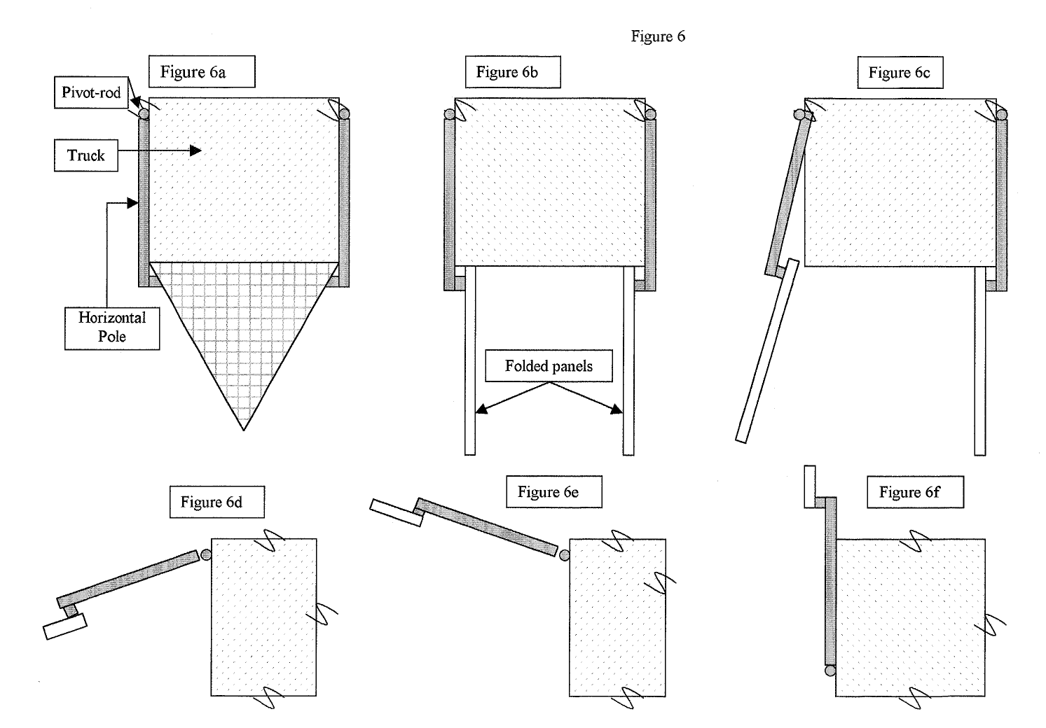

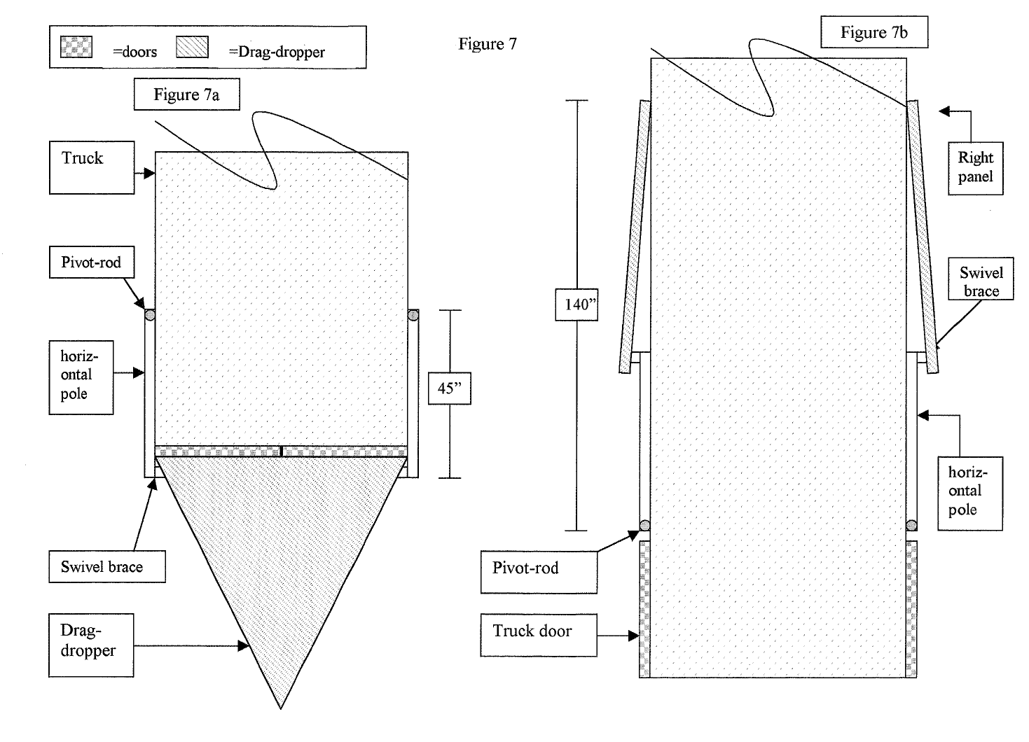

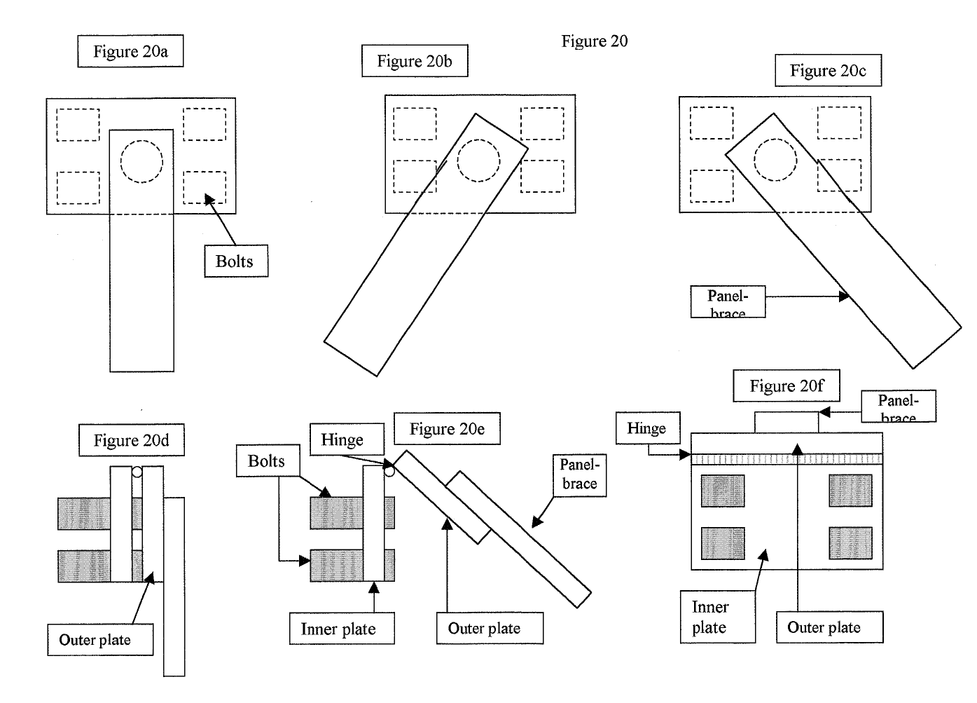

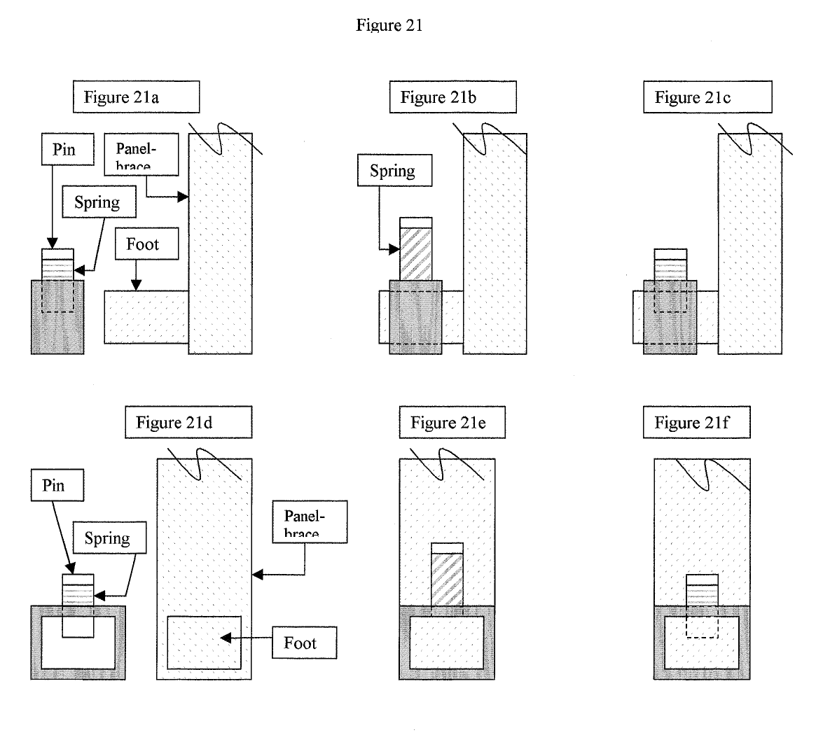

Apparatus used to secure the panels in the storage position: In the event that the truck is used for frequent stops rather than longer-hauls, the driver may wish to leave the Drag-Dropper in the storage position and can secure it in this position using the panel-brace. The panel brace is secured to the truck by its top end to a “top component” (which entails a bolt that is inserted through a top-plate which is connected with a hinge to an inner plate and is mounted with bolts or other means to the truck-side (FIGS. 5 & 20)). This top component allows the pole of the panel-brace to move in both the planes parallel to the truck side (FIGS. 20b and 20c) and perpendicular to it (figure e) so that it may be moved from a neutral position (FIG. 5a) to one in which it overlays the panels (FIG. 5b) and can secure them. The mobile end of the panel brace has a “foot” that inserts into a lock-box (FIGS. 5 & 21). Since the swivel brace (described two paragraphs above this one) allows the vertex of the panel to move, the optimal secured storage position is one in which the vertices of the panels are against the truck wall (FIG. 7) so that air is deflected away from the panels and pushes them against the walls rather than getting between the panels and the walls which could result in material fatigue and potentially dismemberment of the panel from a moving vehicle. The exact dimensions of the panel-brace and its components are dependent upon the material used, but the pole of the panel-brace should be at least 1″ in diameter and the top components' hinge-plates should be at least 2″×2″×0.5″.

1. I claim as my invention the Drag-Dropper which is a device which forms a collapsible structure that can be assembled from a folded position and, when placed behind a truck in the assembled position, forms a modified pyramid that helps streamline the posterior aspect of a large truck.
A. Those that comprise the vertical sides of the Drag-Dropper (FIG. 3a and FIGS. 3b) and those that cover the top and bottom (FIG. 3c and FIGS. 3d). (The narrower side of the trapezoid like structure of the side panels will be referred to as the vertex; the corresponding point of the triangles for the top and bottom panels that contact those vertices when in the assembled position will also be referred to as vertices.) The lengths of their sides is as depicted in FIG. 3 and when assembled they form a structure as depicted in FIG. 2: the vertical sides have a 30° inward deflection from the vehicle's sides, the bottom and top panels deflect 20° from the top and bottom sides of the trailer, respectively.
B. When in the assembled position the Drag-Dropper projects 78″ behind the vehicle (FIG. 2c) and its tip is elevated at least 33″ above the bottom of the trailer edge. Importantly, the assembled panels do not form a single point as in a classical pyramid but rather the point is distributed over at least 24″ to avoid excessive pressure in the event of a collision.
C. The left panel has a small hole which allows the handle of the bottom panel to project through it and a small brace that the handle locks to. The top panel has a small hole in it which allows the locking-bar to pass through it. All of these points will be described more below.
D. The width of each panel are dependent upon the material composition so are not specified here exactly but variations are covered by this patent. However, it is expected that each panel width is at least 0.5″. Likewise, the composition of the panels may be one of several materials and is covered by this patent, but the recommended material is impermeable and rigid (e.g., fiberglass) so the shape is not distorted by wind but can collapse in the event of a forceful posterior collision.
E. The assembly of the panels must follow a specific order such that the internal locking mechanisms can function. This sequence is illustrated in FIG. 8: a) the Drag-Dropper with the panels in the storage position (8a); the left and right panels are swung so they extend behind the truck but remain parallel to the vertical sides of the truck, then the top panel is unfolded from the left panel (8b); the left panel is rotated inward 30° such that the top edge of the top panel is flush against the truck trailer (8c); the right panel rotates inward 30° such that the right and left panels connect at their vertices (8d); the bottom panel is unfolded from the right panel, thus completing the assembled position (8e). To disassemble the Drag-Dropper one would reverse the sequence of events.
F. This patent covers the structures described, whether referred to as the Drag-Dropper or by another name.
II. I claim as my invention those structures on the internal aspect of the assembled Drag-Dropper that assist in locking the panels together.
A. A spring-loaded hinge connects the edges of the left panel and top panel as shown in FIGS. 9 and 10. The spring forces the top panel to unfold and is strong enough to support the weight of the top panel; however it is not excessive and can be easily overcome when the driver pulls on a rope attached to the tip of the top panel when s/he wishes to refold the top panel.
B. Analogously, a hinge (without a spring) permanently connects the edges of the right panel w and the bottom panel as shown in FIGS. 14 and 16. When released, the bottom panel lowers to its unfolded position (FIG. 16). The exact width of the hinge and spring-hinge are dependent upon the material used but would be expected to be less than 0.5″.
C. Connection of the top panel and right panel: A vertical pole, called the “locking-rod” is depicted in FIGS. 11, 13 and 14. This pole is comprised of a top block that is permanently attached to the upper corner of the right panel, has a hinge on its underside that allows rotation in the plan perpendicular to the right panel; the other side of the hinge is a slender shaft that extends into the “bottom block” which is in turn connected to a longer, slender pole which has a handle on its bottom end. The top-block is shaped as a cube but the dimensions of the bottom block are all unequal so that, when viewed from an observer behind the truck, the resulting width is narrow when the handle points towards the observer (FIGS. 11a, 11e) but is wide when the handle is pointed to the left of the truck (FIG. 11c). Similarly, when viewed from the left of the truck, the bottom-bock appears narrow when the handle points towards the observer (11d) or wide when the handle points towards the vertex of the right panel (11f).
D. The locking rod works to secure the top panel and right panel together as depicted in FIG. 13 and as described here: the top panel is unfolded slowly and the distal end (with the handle) of the locking-rod is inserted through a small rectangular hole in the top panel; the handle of the locking-rod is turned towards the left truck side so that the bottom-block's dimensions are concordant with the rectangle's hole (the so-called “guiding position”) and as the top panel unfolds its right tip slides up the locking-rod until it rests just below the top-block. The locking rod is then swung back towards the right panel then the handle is turned counter-clockwise which rotates the top-block into the so called “locking position” such that the top-panel is locked in the unfolded position. As with other elements in the mobile components, the size of the locking-rod and its respective dimensions are dependent upon the material composition. However, an optimal approach would involve the pole width of less than 0.5″, top-block's cube dimension of 2″ and the bottom-block's dimensions of 2″×4″×2″; additionally, the dimensions in FIG. 14 would depend upon the material used but their relative sizes are approximated here.
E. A series of short, rigid cylinders (pegs) are permanently affixed in a vertical position to a ledge (so called peg-ledge) that is in turn attached to the left panel and runs along the lower edge of the left panel (FIG. 15). The peg-ledge extends out at least 3″ and each peg is at least 1″ and has a central hollow as seen by an observer standing at the right side of the truck (15c). The bottom panel has an equal number of circular holes as there are pegs on the peg-ledge (in this example I have made 7 pegs and 7 peg-holes) which have a slightly larger diameter and when unfolded the holes in the bottom panel surround the pegs such that the pegs project through the bottom panel (FIG. 14).
F. The bottom panel has a special apparatus called the locking-arm that has that has locking-fingers extend from it in a parallel manner and can be pulled in a plane parallel to the bottom-panel by a handle that projects through a small window in the left panel (FIG. 17). The locking-arm is affixed to the bottom-panel by guide-bars which allow it to be moved in a plane towards or away from the edge with the holes. Once the bottom panel has been lowered such that the pegs from the left panel project into the bottom panel, the locking arm is pulled towards the left panel such that the fingers pass through the hollow parts of the pegs (FIG. 18) and then the handle is folded against the external component of the left panel (FIG. 17b, 18e) such that it connect with an external brace on the left panel and can be locked with a pad-lock (FIG. 19).
G. To disassemble the Drag-Dropper, the above sequence of steps is done in reverse. Importantly, only one pad-lock is required to secure the structure and, though one could use an alternative method, given the very dangerous consequences of structural collapse if the handle was tampered without the knowledge of the driver, this is a necessary safety component.
III. I claim as my invention those structures on the aspect of the assembled Drag-Dropper that connect it to the trailer.
A. Apparatus to secure the panels to the horizontal poles: The swivel brace depicted in FIG. 22 comprises a simple bolt that passes through two steel trapezoids in turn mounted on a plate that attaches to the right or left panels. There may be any number of these swivel braces (I have drawn in 4 for each of the left and right panels) and the distal tip of a horizontal pole is permanently connected to these when the bolt is passed through a hole in the horizontal pole then welded in place. When the swivel brace is attached to the panel and the horizontal pole, it may assume several angles that allow the panels to move 30° inward when being assembled (FIG. 22b) and facilitate the vertices of the right and panel to be flush against the side of the truck when in the storage position (FIG. 22c).
B. Apparatus used to swing the panels: The pivot-rod is a vertical rod secured to the trailer by anchors and that has a number of stubs projecting perpendicular from it, the latter of which are hollow and accept the proximal tips of the horizontal poles (FIG. 23). The exact number of stubs can vary depending upon the size of the vehicle, and the length of the horizontal poles can also vary so that the pivot-rod could be located close to the back door (in the case where the back-door is opened vertically as in a roll-up door) or significantly far from the back doors (in the case where the back-door is swung open and lies against the sides of the truck. The horizontal poles chosen for a given installment may be short or long depending upon the location of the pivot rod, but each has a right-angle (so called L-arm as in FIG. 22) just prior to attachment with the swivel joint; the distance of this L-arm may be varied upon the size of the vehicle but generally should be short so the panels make contact just inside the edge of the side walls (but far enough in so air can not accidentally enter the interior of the assembled Drag-Dropper). The horizontal poles would be securely affixed to the stubs and the anchors of the pivot-rods would by a securely affixed to the trailer when the Drag-Dropper and its supporting structures are installed on the truck. When swung into the storage position (FIGS. 4,6,7) the panels move in a semi-circle whose center is the pivot-rod and radius is sum of the length of the stubs, horizontal pole and the length of the panels.
C. Apparatus used to secure the panels in the storage position: In the event that the truck is used for frequent stops rather than longer-hauls, the driver may wish to leave the Drag-Dropper in the storage position and can secure it in this position using the panel-brace. The panel brace is secured to the truck by its top end to a “top component” (which entails a bolt that is inserted through a top-plate which is connected with a hinge to an inner plate and is mounted with bolts or other means to the truck-side (FIGS. 5 & 20)). This top component allows the pole of the panel-brace to move in both the planes parallel to the truck side (FIGS. 20b and 20c) and perpendicular to it (figure e) so that it may be moved from a neutral position (FIG. 5a) to one in which it overlays the panels (FIG. 5b) and can secure them. The mobile end of the panel brace has a “foot” that inserts into a lock-box (FIGS. 5 &21). Since the swivel brace (described two paragraphs above this one) allows the vertex of the panel to move, the optimal secured storage position is one in which the vertices of the panels are against the truck wall (FIG. 7) so that air is deflected away from the panels and pushes them against the walls rather than getting between the panels and the walls which could result in material fatigue and potentially dismemberment of the panel from a moving vehicle. The exact dimensions of the panel-brace and its components are dependent upon the material used, but the pole of the panel-brace should be at least 1″ in diameter and the top components' hinge-plates should be at least 2″×2″×0.5″.
